(19) United States
(12) Patent Application Publication
(10) Pub. No.: US 2005/0134708 A1
(43) Pub. Date: Jun. 23, 2005

(54) Control method of digital camera

(75) Inventors: Byoung-kyu Lee, Seongnam-si (KR); Kyung-tai Nam, Seongnam-si (KR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 11/004,115

(22) Filed: Dec. 3, 2004

(30) Foreign Application Priority Data
Dec. 17, 2003 (KR) 2003-92742

(51) Int. Cl. G04B 19/24

(52) U.S. Cl. 348/240.2

(57) ABSTRACT

A control method of a digital camera is provided. In the method, information regarding data stored in a recording medium is displayed, and data selected by a user is processed. The method includes reading the data stored in the recording medium, sorting the read data by date, displaying, sequentially by date, information regarding the sorted data, and not displaying the dates on which data was not stored. The read data is sorted by date and file type, and the information regarding the sorted data is displayed by file type. According to the method, a lot of information can be provided on the same screen, and a desired image can be easily accessed. In addition, a group of data stored in the recording medium can be processed at one time.

### BACKGROUND OF THE INVENTION

This application claims the priority of Korean Patent Application No. 2003-92742, filed on Dec. 17, 2003, in the Korean Intellectual Property Office, the disclosure of which is incorporated herein in its entirety by reference.

1. Field of the Invention

The present invention relates to a control method of a digital camera, and more particularly, to a control method of a digital camera in which data stored in a recording medium is displayed, and data selected by a user is processed.

2. Description of the Related Art

Recently, the storage capacity of digital camera recording mediums, such as memory cards, has increased through tens to hundreds of megabytes. Accordingly, hundreds of images can be stored in digital cameras.

As the storage capacity increases, users often leave images from many photography sessions stored in the camera for long periods of time, rather than transferring them to a computer or other storage device. However, accessing the images stored in the camera is inconvenient.

A conventional digital camera (model: EXLIM) manufactured by Casio Computer Co., Ltd, displays still images photographed on each date as thumbnails on a calendar, when in a reproducing mode. Specifically, referring to FIG. 1, a photograph history is displayed on a calendar. The first still image photographed on each date is displayed under that date, in the thumb-nail method. For example, if nine photographs were taken on September 18, the first of these is displayed under that date, so that images stored in the recoding medium can be more easily retrieved.

However, in this disclosure, no information other than the still image first photographed on each date is provided. In addition, information regarding moving images or voice records is not provided. Thus, it is still inconvenient to search for desired data.

Since a calendar is used, dates when photographs were not taken are also displayed on the screen, wasting space and limiting the amount of information that can be provided on the screen. Moreover, since dates when photographs were not taken are displayed, the user has to press keys more times to move to a desired date, which significantly undermines the ease of searching. For example, referring to FIG. 1, a user must press control keys dozens of times to retrieve images taken on September 18 after viewing images taken on August 15, although no images were taken between the two dates.

### SUMMARY OF THE INVENTION

The present invention provides a control method of a digital camera which reduces the number of times that a user has to press keys, thereby enhancing the ease of searching.

The present invention also provides a control method of a digital camera in which more information regarding data stored in the digital camera can be provided.

The present invention also provides a control method of a digital camera in which a group of data can be processed at one time.

According to an aspect of the present invention, there is provided a control method of a digital camera in which information regarding data stored in a recording medium is displayed and the data selected by a user is processed. The method includes reading the data stored in the recording medium; sorting the data by date; and displaying information regarding the sorted data sequentially by date, without displaying dates when no data was stored.

The data may be sorted by date and file type, and the information regarding the sorted data may be displayed by file type.

The displayed information regarding the sorted data may include numbers of still images, moving images, and voice records stored on each date.

The method may further include selecting a date desired by a user, from the dates displayed. The method may further include displaying reduced images stored on the selected date.

The method may further include selecting a reduced image from the reduced images that are displayed; and enlarging the selected image to its original size and displaying the original image.

The method may further include displaying functions that can be performed on a group of data stored on the selected date; and processing the group of data at one time according to a function selected by the user from the displayed functions.

The displayed functions may include slide show, resize, delete all, and protect functions.

### BRIEF DESCRIPTION OF THE DRAWINGS

The above and other features and advantages of the present invention will become more apparent by describing in detail exemplary embodiments thereof with reference to the attached drawings in which:

FIG. 1 is a screen of a conventional digital camera on which stored data is displayed;

FIG. 2 is a perspective view illustrating the back of a digital camera according to an embodiment of the present invention;

FIG. 3 is a schematic block diagram of the digital camera of FIG. 2;

FIG. 4 is a flowchart illustrating a control algorithm performed by a digital signal processor (DSP) when the digital camera displays information regarding data stored in a recording medium and reproduces an original image based on image data selected by a user;

FIG. 5 is a screen obtained as a result of performing A1 illustrated in FIG. 4;

FIG. 6 is a screen obtained as a result of performing A6 through A9 illustrated in FIG. 4;

FIG. 7 illustrates the transition from A10 to A11 illustrated in FIG. 4;

FIG. 8 is a flowchart illustrating a control algorithm performed by the DSP when the digital camera displays the information regarding the data stored in the recording medium and processes a group of data selected by the user at one time; and

FIGS. 9, 10, and 11 are screens obtained as a result of performing B6, B9, and B12, respectively, illustrated in FIG. 8.

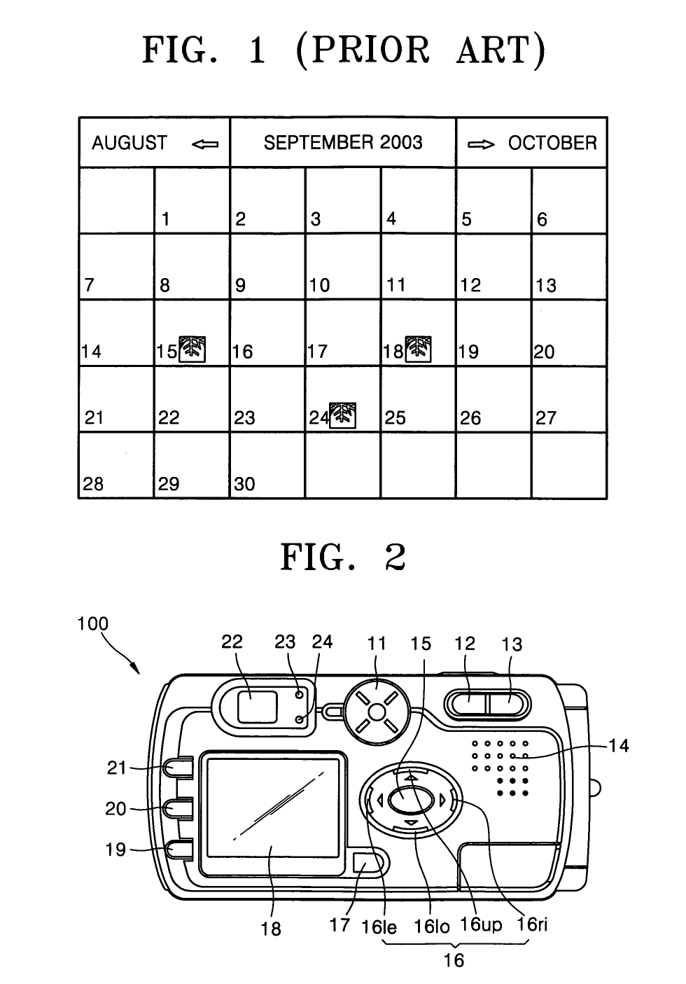

### DETAILED DESCRIPTION OF THE INVENTION

FIG. 2 is a perspective view illustrating the back of a digital camera 100 according to an embodiment of the present invention. Referring to FIG. 2, the digital camera 100 includes a mode dial 11, a wide/9-division button 12, a tele/digital zoom button 13, a speaker 14, a menu/OK button 15, a control button 16, a reproducing mode button 17, an LCD panel 18, an LCD/information button 19, an MF/delete button 20, a play/stop button 21, a viewfinder 22, a flash check lamp 23, and an automatic focus check lamp 24.

The mode dial 11 is used for selecting the operating mode of the digital camera 100, such as a still image photographing mode, a moving image photographing mode, an audio recording mode, and a night view photographing mode.

The wide/9-division button 12 is used to enlarge images stored or display several images at the same time. The tele/digital zoom button 13 is for reducing enlarged images back to their original sizes.

The menu/OK button 15 is used to display a menu screen for each operating mode of the digital camera 100 on the LCD panel 18 or set a changed value. In an embodiment of the present invention, the menu/OK button 15 is used to display the menu screen on the LCD panel 18 in the reproducing mode or a function-setting mode.

The control button 16 includes an up button 16up, a right button 16ri, a down button 16lo, and a left button 16le. The control button 16 is used by a user to move a cursor between commands in a menu or to change a set value of a command.

The reproducing mode button 17 is for operating the digital camera 100 in the reproducing mode. In an embodiment of the present invention, if the set value of a “DATE SORT” command is set to On, information regarding data stored in a recording medium is displayed by date on the LCD panel 18.

The LCD panel 18 displays an image of a subject being photographed. In an embodiment of the present invention, the LCD panel 18 displays reduced and original images using the data stored in the recording medium as well as various menu screens that a user can select.

The LCD/information button 19 is used by a user to control the operation of the LCD panel 18. For example, if a user presses the LCD/information button 19 once, an image and associated information are displayed on the LCD panel 18. If the user presses the LCD/information button 19 twice, only the image is displayed on the LCD panel 18. If the user presses the LCD/information button 19 three times, the LCD panel 18 is turned off.

The play/stop button 21 is for reproducing images or voice using the stored data. The automatic focus check lamp 24 operates when automatic focusing has finished. The flash check lamp 23 operates when the flash is on standby.

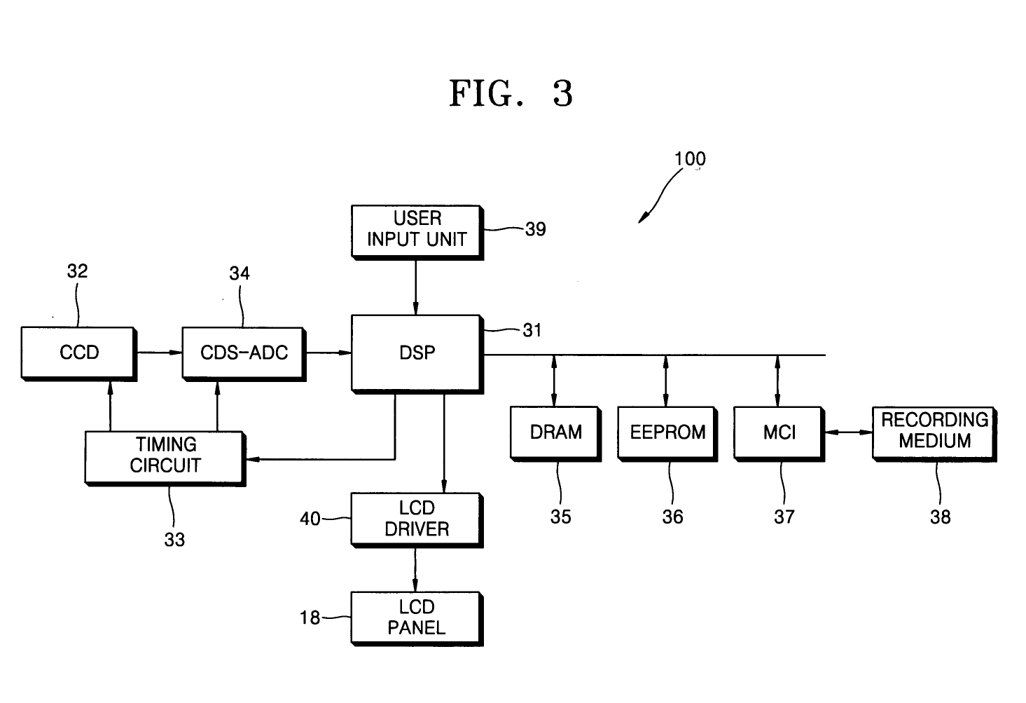

FIG. 3 is a schematic block diagram of the digital camera 100 of FIG. 2. Referring to FIG. 3, the digital camera 100 includes a charged coupled device (CCD) 32, which is an image pick-up device, a digital signal processor (DSP) 31, which is a one-chip microcomputer, a correlation-double-sampler-and-analog-to-digital converter (CDS-ADC) 34 connected to the CCD 32, and a timing circuit 33 controlling the CCD 32 and the CDS-ADC 34.

The digital camera 100 further includes storage devices, i.e., a dynamic random access memory (DRAM) 35, an electrically erasable and programmable read only memory (EEPROM) 36, and a recording medium 38 inserted into or removed from a memory card interface (MCI) 37. The digital camera 100 also includes an LCD driver 40 and the LCD panel 18 as a display device, and a user input unit 39.

The DSP 31 compresses or decompresses image data, processes various digital signals such as audio data, and controls each element of the digital camera 100.

The CCD 32 converts an image of a subject into an analog signal. The DSP 31 controls the timing circuit 31 to control the operations of the CCD 32 and the CDS-ADC 34 connected to the CCD 32.

The CDS-ADC 34 processes an output signal of the CCD 32, eliminates high frequency noise, adjusts amplitude, and then converts the output signal into a digital signal.

The DSP 31 processes the digital signal from the CDS-ADC 34 and generates a digital image signal composed of luminance and chrominance signals.

The DRAM 35 temporarily stores a digital image signal from the DSP 31. Images stored in the DRAM 35 are compressed by the DSP 31 and finally stored in the recording medium 38 in a still image file or a moving image file in a predetermined format.

The recording medium 38, i.e., a memory card, is inserted into or removed from the MCI 37. The recording medium 38 stores a still image file and a moving image file, in which information regarding images is recorded, and an audio file in which audio data is recorded. In the present invention, data stored in the recording medium 38 is read and sorted such that diverse information regarding the data can be provided.

The EEPROM 36 stores algorithms needed for the operation of the DSP 31 and setting data. The LCD driver 40 receives a digital image signal from the DSP 31 and displays the digital image signal on the LCD panel 18. The LCD driver 40 and the LCD panel 18 display an image while photographing. In an embodiment of the present invention, the LCD driver 40 and the LCD panel 18 display information regarding data stored in the recording medium 38 and diverse menu screens that a user can select. In addition, the LCD driver 40 and the LCD panel 18 reproduce reduced and original images using the stored data.

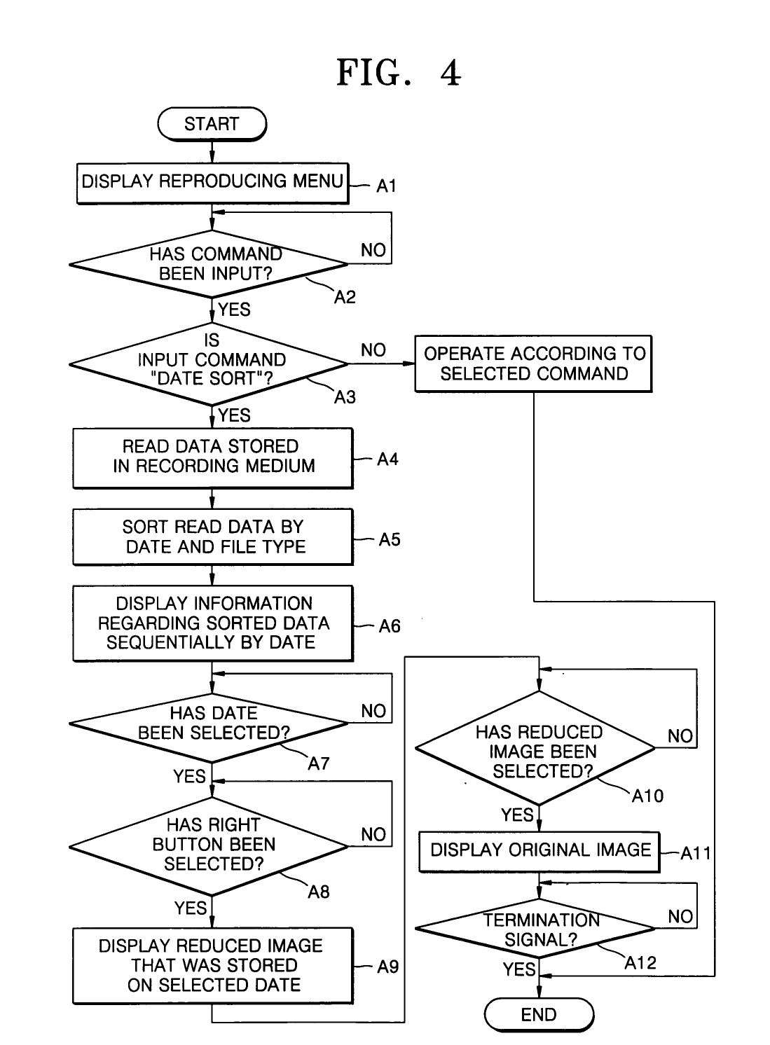

FIG. 4 is a flowchart illustrating a control algorithm performed by the DSP 31 when the digital camera 100 displays information regarding the data stored in the recording medium 38 and reproduces an original image based on image data selected by a user.

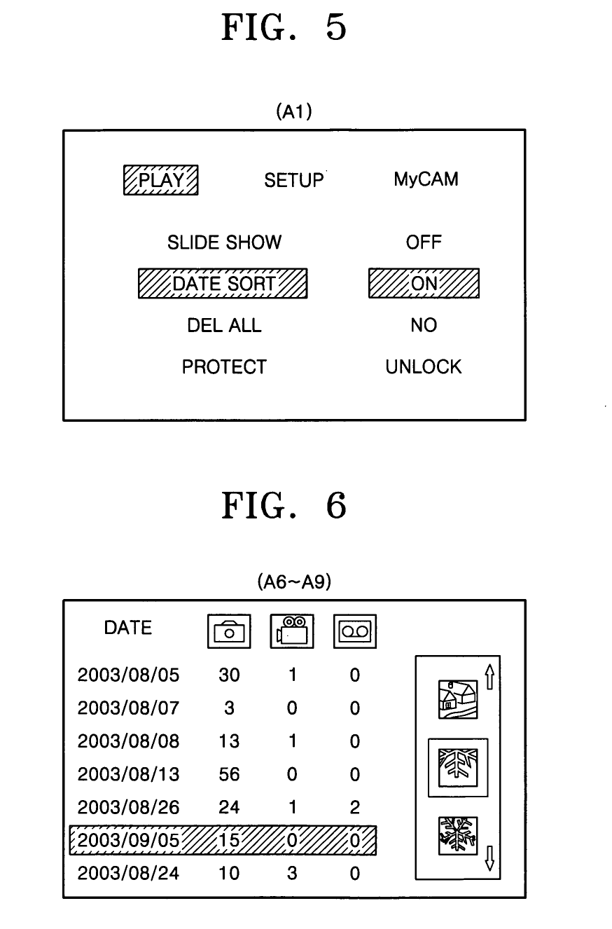

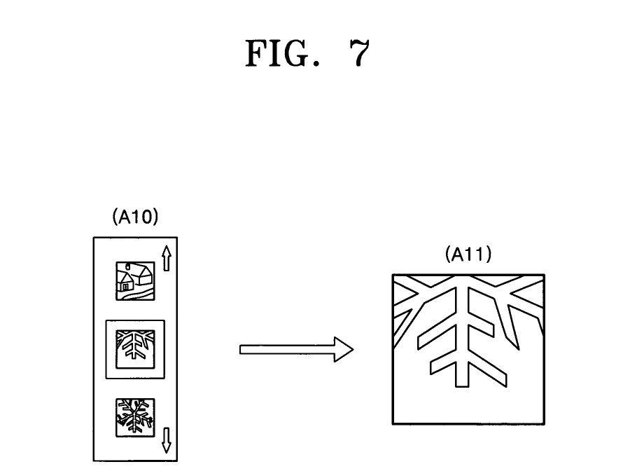

FIG. 5 is a screen obtained as a result of performing A1 illustrated in FIG. 4. FIG. 6 is a screen obtained as a result of performing A6 through A9 illustrated in FIG. 4. FIG. 7 illustrates the transition from A10 to A11 illustrated in FIG. 4.

A method of displaying information regarding data stored in the recording medium 38 and retrieving image data of original images which will be reproduced will now be described with reference to FIGS. 4 through 7.

If the reproducing mode button 17 is selected, the reproducing mode starts. Then, the menu/OK button 15 is manipulated, and a menu screen is displayed on the screen (A1). As illustrated in FIG. 5, “SLIDE SHOW,” “DATE SORT,” “DEL ALL,” and “PROTECT” commands are displayed on the menu screen.

The user selects a command (A2). Using the control button 16, the user moves the cursor to the “DATE SORT” command and selects On from an On/Off option. When the user presses the menu/OK button 15, the “DATE SORT” command is selected (See FIG. 5). If the “DATE SORT” command is set to On (A3), the digital camera 100 reads data from the recording medium 38 (A4).

Data is sorted sequentially by photographed date based on information regarding photographed dates that are recorded in the data (A5). The data can be sorted by file type, for example, by still image, moving image, and audio file. Specifically, the recording medium 38 stores data in a still image file, a moving image file, and an audio file, according to the contents of the data. Therefore, the DSP 31 can sort the data by file type.

The information regarding photographed dates can be read from additional information recorded in the files. The additional information is given to the data by the digital camera 100 and is tag information of an exchangeable image file format (Exif).

Next, information is displayed (A6). The information obtained from A5 is displayed on the LCD panel 18. Specifically, the LCD driver 40 receives a signal from the DSP 31 and displays an image on the LCD panel 18.

FIG. 6 is a screen displayed on the LCD panel 18. Referring to FIG. 6, information regarding data stored in the recording medium 38 is displayed vertically and sequentially by photographed date. In addition, information regarding data stored on the same date can be displayed horizontally by type. Specifically, the numbers of still images, moving images, and voice records stored are displayed in a text format next to the corresponding dates. By displaying such information in a text format, it is possible to provide diverse information on the same screen without restriction by space limitations.

Further, only photographed dates, i.e., dates when data was stored, are displayed. Dates when no data was stored are not displayed. Thus, dates are displayed non-consecutively, thereby reducing the number of times that a user has to manipulate keys in a subsequent date selection process, and improving the ease of searching. Since unnecessary dates are not displayed, the use of space on the screen is improved, and thus more information can be provided on the screen.

The user selects a date to reproduce images stored on that date (A7). Using the control button 16, the user selects a desired date. Since only the photographed dates are displayed in A6, a simple manipulation of keys will allow the user to move the cursor to the desired date.

The selected date is input to the digital camera 100. If the user manipulates the right button 16ri (A8), the DSP 31 reproduces a reduced image stored on the selected date (A9). The reduced image uses reduced image data stored in a file in addition to original image data. Hence, the reduced image can be quickly retrieved and reproduced. The reduced image data requires less memory capacity than the original image data.

After viewing the reduced image stored on the selected date, the user selects the reduced image to reproduce the original image (A10). The user can easily view the contents of the original image through the reduced image and select image data of the original image. The user may select the reduced image using the control button 16.

The reduced image selected by the user is enlarged to the original image as illustrated in FIG. 7 (A11). The DSP 31 enlarges compressed image data read from a selected image file, for example, data compressed in a joint photographic expert group (JPEG) structure, and transmits the enlarged image data to the LCD driver 40 such that the original image can be reproduced.

Finally, when a termination signal, for example, a mode-conversion command signal is received (A12), the reproducing mode is terminated.

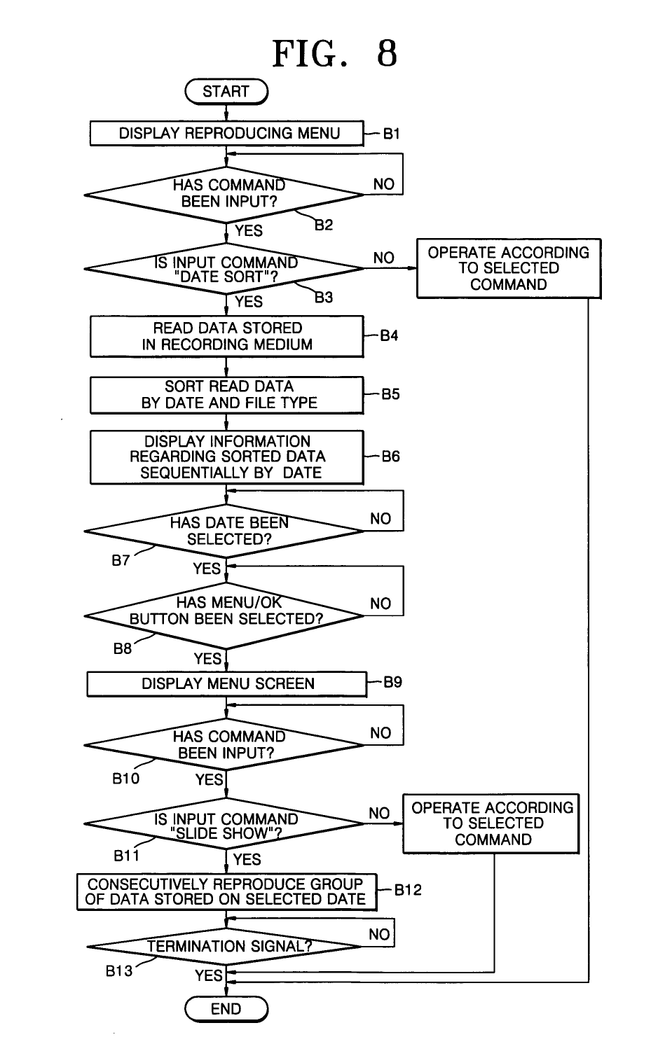

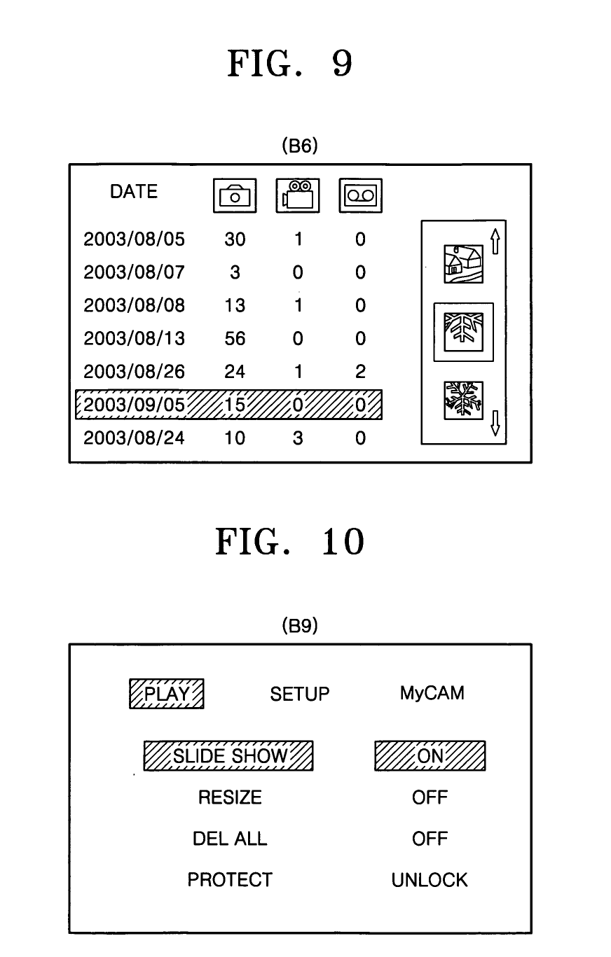

FIG. 8 is a flowchart illustrating a control algorithm performed by the DSP 31 when the digital camera 100 displays information regarding data stored in the recording medium 38 and processes a group of data selected by a user at one time. FIGS. 9, 10, and 11 are screens obtained as a result of performing B6, B9, and B12, respectively, illustrated in FIG. 8.

The control algorithm performed by the DSP 31 when a user wishes to process data stored on a date at one time will now be described with reference to FIGS. 8 through 11.

If the reproducing mode button 17 is selected, the reproducing mode starts. Then, if the menu/OK button 15 is manipulated, a menu screen is displayed on the screen (B1). As illustrated in FIG. 5, “SLIDE SHOW,” “DATE SORT,” “DEL ALL,” and “PROTECT” commands are displayed on the menu screen.

A user selects a command (B2). If the “DATE SORT” command is set to On (B3), the digital camera 100 reads data from the recording medium 38 (B4). The digital camera 100 sorts the data by file type and date (B5) and displays information regarding the data by date (B6) and by file type (See FIG. 9).

After viewing the information displayed in B6, the user selects a date (B7). By selecting a date, the user can designate a group of data to be processed at one time. Information regarding the selected date is input to the DSP 31.

If the menu/OK button 15 is manipulated (B8), a menu screen is displayed (B9). Referring to FIG. 10, the menu screen includes “SLIDE SHOW,” “RESIZE,” “DEL ALL,” and “PROTECT” commands. If the user wishes to set the “SLIDE SHOW” command, the user moves the cursor to “SLIDE SHOW” and sets the value of the “SLIDE SHOW” command to On from an On/Off option using the control button 16. Then, if the user presses the menu/OK button 15, the “SLIDE SHOW” command is set (B11).

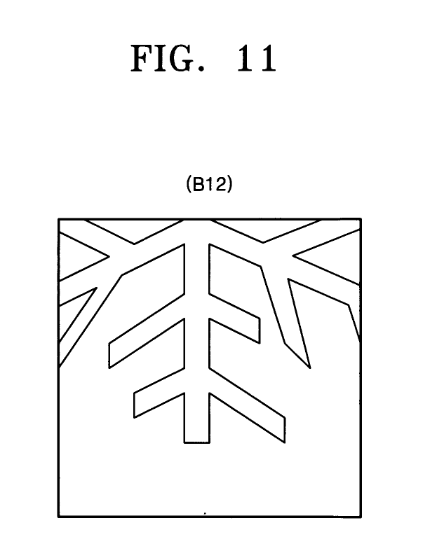

If a command set in B11 is input to the DSP 31, a group of data is processed by the DSP 31 according to the set command (B12). For example, if the “SLIDE SHOW” command is set, a group of data selected is consecutively reproduced (see FIG. 11). If the “RESIZE” command is set, the sizes of all elements of a group of data are changed. If the “DEL ALL” command is set, all of a group of data photographed on a selected date is deleted. If the “PROTECT” command is set, a particular group of data is protected from deletion even when the MF/delete button 20 is pressed.

Finally, when a termination signal, for example, a mode-conversion command signal, is received (B13), the reproducing mode is terminated.

As described above, a control method of a digital camera according to an embodiment of the present invention can produce the following effects.

First, information regarding data stored in a recording medium is displayed in a text format, saving space on the screen. Thus, a lot of information can be provided on the same screen.

Second, the number of times that a user has to manipulate buttons to select a date is reduced, thereby improving the ease of key manipulation. In the present invention, only dates when data was stored are displayed, so that a user can easily select one with simple manipulation of keys.

Third, a group of data stored in the recording medium can be processed at one time. According to the present invention, a group of data stored on the same date can be consecutively reproduced or all deleted. Moreover, the sizes of the elements of the group of data can be changed.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of controlling a digital camera in which information regarding data stored in a recording medium is displayed, the method comprising:
reading the data stored in the recording medium;
sorting the data by date; and
displaying, sequentially by date, information regarding the data and not displaying dates on which data was not stored.

2. The method of claim 1, wherein the data further comprises a plurality of file types and the information regarding the sorted data is displayed by file type.

3. The method of claim 1, wherein the displayed information regarding the sorted data includes the numbers of still images, moving images, and voice records stored on each date.

4. The method of claim 1, further comprising selecting a date desired by a user from the dates displayed.

5. The method of claim 4, further comprising displaying the reduced images stored on the selected date.

6. The method of claim 5, further comprising:
selecting a reduced image from the reduced-images that are displayed; and
enlarging the selected image to its original size and displaying the original image.

7. The method of claim 4, further comprising:
displaying functions that can be performed on a group of data stored on the selected date; and
processing the group of data at one time according to a function selected by the user from the displayed functions.

8. The method of claim 7, wherein the displayed functions include slide show, resize, delete all, and protect functions.

9. A digital camera having a display that can be used to display information regarding data stored in a recording medium, which comprises:
means for reading the data stored in the recording medium;
means for sorting the data by date; and
means for displaying, sequentially by date, information regarding the data and not displaying dates on which data was not stored.

10. The digital camera of claim 9, wherein the data further comprises a plurality of file types and the means for displaying the information regarding the sorted data sequentially by date and by file type.

11. The digital camera of claim 9, wherein the displayed information regarding the sorted data includes the numbers of still images, moving images, and voice records stored on each date.

12. The digital camera of claim 9, further comprising means for selecting a date desired by a user from the dates displayed.

13. The digital camera of claim 12, further comprising means for displaying reduced images stored on the selected date.

14. The digital camera of claim 13, further comprising:
means for selecting a reduced image from the reduced images that are displayed; and
means for enlarging the selected image to its original size and displaying the original image.

15. The digital camera of claim 12, further comprising:
means for displaying the functions that can be performed on a group of data stored on the selected date; and
means for processing the group of data at one time according to a function selected by the user from the displayed functions.

16. The digital camera of claim 15, wherein the displayed functions include slide show, resize, delete all, and protect functions.
